(19) United States
(12) Patent Application Publication
(10) Pub. No.: US 2022/0230106 A1
(43) Pub. Date: Jul. 21, 2022

(54) SYSTEMS AND METHODS FOR ASSET INTEGRITY MANAGEMENT AND MONITORING OF SAFETY CRITICAL ELEMENTS

(71) Applicant: Saudi Arabian Oil Company, Dhahran (SA)

(72) Inventors: Nasser Balhareth, Dammam (SA); Suhaim Shehri, Dammam (SA); Suliman Abdullah Al-Mousa, Al Khobar (SA); Md Fazlul Alam Chowdhury, Dhahran (SA); Mohammed Bin Garad, Khobar (SA)

(73) Assignee: Saudi Arabian Oil Company, Dharhan (SA)

(21) Appl. No.: 17/153,143

(22) Filed: Jan. 20, 2021

(51) Int. Cl. G06Q 10/06

(52) U.S. Cl. CPC G06Q 10/0635; G06Q 10/06393

(57) ABSTRACT

Systems and methods are provided for asset integrity monitoring for organizations having multiple locations, multiple facilities or production activities. A visualization platform is provided for presenting status points from a variety of sources for different systems including maintenance, inspection, and operation programs to allow timely intervention by decision makers (i.e. operators, foremen, supervisors, managers, etc.) for all activities of an organization and to ensure safe operation. In addition, systems and methods described herein provide scalable solutions, allow for customization to organizational structure, and definition of requirements of all safety critical elements. Methods include monitoring safety critical elements by integrating data from a plurality of sources and updating integrity performance standards for safety critical elements and determining status levels for each safety critical element. Methods also include generating reports for the organizational structure using the performance standard determinations and generating reports including graphical visualizations of operational status across the organizational structure.

### BACKGROUND

The present disclosure relates to the asset integrity management systems (AIMS), for monitoring an entire organizational structure having many safety critical elements and for visualization of operational status across the entire organization.

### BRIEF SUMMARY

Ensuring the integrity of the safety critical elements (SCEs) within an organization is necessary to prevent loss, ensure safety and maintain operations. Monitoring can play a great role towards timely intervention, assurance of asset integrity, and more importantly mitigating risk levels to As Low As Reasonably Practicable (ALARP). In addition, monitoring of assets can allow for safe production by large facilities. Monitoring assets across an organization can require tremendous amounts of time and effort, especially when manual inspection is required. With large production facilities, monitoring can be difficult with conventional methods due to different sources and types of monitoring data. Conventional methods may not provide timely results for large organizations including several thousand assets and may not be able to provide updates on a daily basis for all corporate safety critical assets.

The present disclosure introduces systems and methodology for asset integrity monitoring that works accurately across an organization having multiple locations, multiple facilities and for a wide range of production activities. The systems and methodology disclosed herein provide solutions for fetching status from millions of data points for hundreds of thousands of safety critical elements. Moreover, systems and methods provide a visualization platform for presenting status points from a variety of sources for different systems including maintenance, inspection, and operation programs. Systems and methods can provide visualizations to allow timely intervention by decision makers (i.e. operators, foremen, supervisors, managers, etc.) for all activities of an organization and to ensure safe operation. In addition, systems and methods described herein provide scalable solutions, allow for customization to organizational structure, and definition of requirements of all safety critical elements.

The present disclosure introduces a novel way to monitor safety critical elements across an organization by integrating data from sources into an asset integrity monitoring system, verification of integrity performance standards for each safety critical element, and determination of compliance status. The integration of data for each safety critical element may utilize organization structure, such as at least one parameter indicative of an organizational hierarchy, hardware barrier classifications, and integrity performance standards. In this manner, data from multiple sources can be used to assess a safety critical element. Data may also be linked to the safety critical elements and mapped to the organizational structure and hardware barriers for assessing compliance. Integration of data also allows for generating reports and visualizations providing metrics and determinations characterizing compliance of the organization and performance of maintenance and safety assurance tasks.

In accordance with embodiments of the present disclosure, an asset integrity management system is provided for monitoring safety critical elements of an organizational structure. The system includes an integration server, an analysis server, a warehouse server, a report server, and a web server. The integration server receives data from a plurality of data sources for a plurality of safety critical elements of the organizational structure, links received data to safety critical elements of the organizational structure, and outputs the data to the analysis server and the warehouse server. The warehouse server stores data received from the integration server into data records for safety critical elements, wherein each safety critical element data record includes at least one organizational parameter, a hardware barrier parameter and integrity performance standard. The analysis server receives the data from the integration server and updates an integrity performance standard for each safety critical element associated with the data, wherein updating the integrity performance standard includes determining a status level for each safety critical element associated with the data records using a first status indicating completion of an inspection plan, a second status indicating completion of an inspection plan with at least one finding to be corrected, and a third status to indicate an incomplete safety plan. The analysis server outputs each performance standard determination for safety critical elements with at least one of a second status and third status to the warehouse server. The warehouse server stores performance standard determinations of the analysis server into data records of safety critical elements with at least one of a second status and third status. The report server is configured to generate a report for the organizational structure using the performance standard determinations for safety critical elements determined by the analysis server, data stored by the warehouse server, and safety critical element data records for the organization, the report identifying safety critical elements with the first status, the second status, and the third status. The web server is configured to output the report to at least one device as a graphical visualization of operational status of safety critical elements across the organizational structure, the graphical visualization configured to present safety critical elements using at least one of an organizational parameter, and a hardware barrier parameter.

According to embodiments, the integration server receives data from at least one of an enterprise resource report, plant data source, maintenance log, emergency shutdown bypass system, and manual report, and wherein the integration server receives data from data sources in a plurality of locations.

According to embodiments, the integration server links received data from the plurality of data sources using source identifiers for the data sources, and wherein each safety critical element data record identifies data sources for integrity performance standards.

According to embodiments, the analysis server updates integrity performance standards for each safety critical element associated with received data, the integrity performance standards including at least one verification task defined for each safety critical element, wherein the analysis server uses data determined by the integration server to determine task completion and status level.

According to embodiments, the analysis server outputs determinations for a second status and third status with identification of incomplete tasks of integrity performance standards.

According to embodiments, the warehouse server stores a data record for each safety critical element, wherein each safety critical element data record includes a plurality of organizational parameters for the organizational structure, a hardware barrier parameter to classify safety critical elements, and an integrity performance standard for the data record based on safety critical element type.

According to embodiments, the report server outputs a compliance value of safety critical elements for the organization, a compliance value of safety critical elements for the first status, a compliance value of safety critical elements for the second status, and a compliance value of safety critical elements for the third status.

According to embodiments, the report server outputs at least one compliance value for a selected organizational parameter, wherein the at least one compliance value for a selected organizational parameter is presented using data records for safety critical elements.

According to embodiments, the report server outputs at least one compliance value for hardware barrier parameters, wherein the at least one compliance value for hardware barrier parameters includes graphical display elements indicating status for each hardware barrier.

According to embodiments, the web server is configured to output the report as an interactive display, wherein display elements of the interactive display are presented based on compliance values of the organization, an organizational parameter, and a hardware barrier parameter.

In accordance with other embodiments, the present disclosure introduces methodology for monitoring safety critical elements of an organizational structure in an asset integrity management system including an integration server, an analysis server, a warehouse server, a report server, and a web server. The method includes receiving, by the integration server, data from a plurality of data sources for a plurality of safety critical elements of the organizational structure, linking, by the integration server, received data to safety critical elements of the organizational structure, and outputting, by the integration server, the data to the analysis server and the warehouse server. The method also includes storing, by the warehouse server, data received from the integration server into data records for safety critical elements, wherein each safety critical element data record includes at least one organizational parameter, a hardware barrier parameter and integrity performance standard. The method also includes updating, by the analysis server, an integrity performance standard for each safety critical element associated with the data, wherein updating the integrity performance standard includes determining a status level for each safety critical element associated with the data records using a first status indicating completion of an inspection plan, a second status indicating completion of an inspection plan with at least one finding to be corrected, and a third status to indicate an incomplete safety plan. The method also includes outputting, by the analysis server, each performance standard determination for safety critical elements with at least one of a second status and third status to the warehouse server. The method also includes storing, by the warehouse server, performance standard determinations of the analysis server into data records of safety critical elements with at least one of a second status and third status. The method also includes generating, by the report server, a report for the organizational structure using the performance standard determinations for safety critical elements determined by the analysis server, data stored by the warehouse server, and safety critical element data records for the organization, the report identifying safety critical elements with the first status, the second status, and the third status. The method also includes outputting, by the web server, the report to at least one device as a graphical visualization of operational status of safety critical elements across the organizational structure, the graphical visualization configured to present safety critical elements using at least one of an organizational parameter, and a hardware barrier parameter.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a graphical representation of an organizational structure and asset integrity monitoring system according to the present disclosure;

FIG. 2 illustrates systems and methodology for asset integrity monitoring of safety critical elements according to the present disclosure;

FIG. 3 illustrates a process for status monitoring of safety critical elements;

FIG. 4 illustrates a graphical representation of an exemplary organization structure;

FIG. 5 illustrates a graphical representation of a template for an organizational hierarchy and asset definition;

FIG. 6 illustrates a visualization for status monitoring of safety critical elements of an organization;

FIG. 7 illustrates a visualization for status monitoring of an organizational level;

FIG. 8 illustrates a visualization for status monitoring of hardware barriers;

FIG. 9 illustrates a server configuration;

FIG. 10 illustrates a graphical representation of a integrity performance standard for safety critical elements; and

FIG. 11 illustrates visualizations of for status monitoring safety critical elements including a geographic representation.

### DETAILED DESCRIPTION

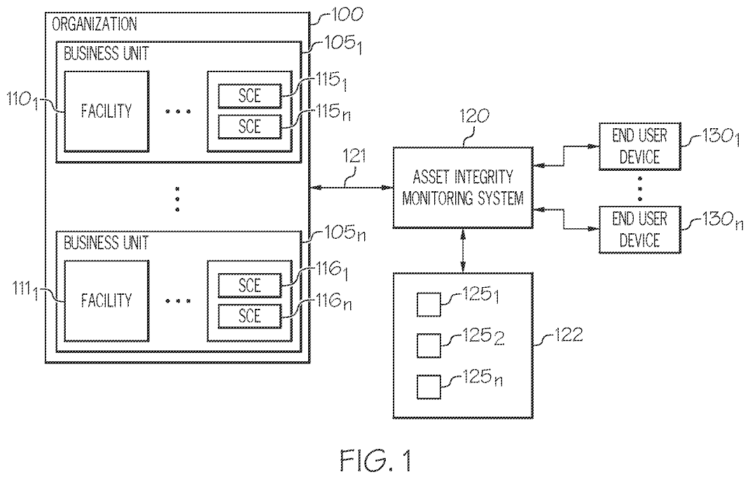

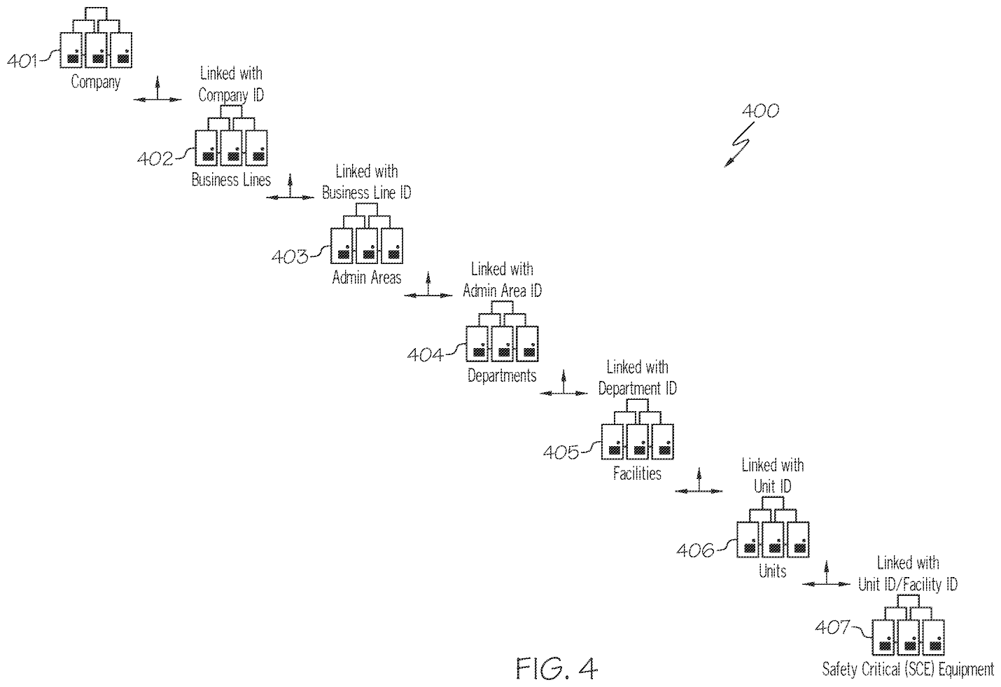

Referring to FIG. 1, a system is provided for monitoring assets of organization 100. Organization 100 includes a plurality of assets, referred to as safety critical elements (SCEs), requiring monitoring. SCEs may be assets that are meant either to prevent incidents from happening or mitigate the consequences of incidents in one or more facilities of an organization. Large scale organizations and production facilities can include SCEs in the hundreds of thousands. Maintaining the integrity of SCEs is necessary to assure risk mitigation of operational facilities and to safely meet daily production targets for production facilities. In the absence of monitoring, consequences of unmanaged risk may lead to asset damage, loss of production, negative environmental impact and even loss of human life. Solutions described herein provide asset integrity monitoring system 120 for organizations with large distributions of assets across one or more locations, facilities and business units. Organization 100 represents an exemplary organizational structure including a plurality of business units 105₁₋ₙ each having a plurality of facilities, 110₁₋ₙ and 111₁₋ₙ. Business units 105₁₋ₙ may be business lines of an organization and may each include a plurality of facilities (e.g., locations, plants, production centers, etc.). Each facility of business units 105₁₋ₙ may include a plurality of safety critical elements. By way of example, FIG. 1 shows facility 110ₙ including safety critical elements (SCEs) 115₁₋ₙ and facility 111ₙ includes safety critical elements (SCEs) 116₁₋ₙ. Asset integrity monitoring system 120 includes one or more components to receive and integrate data 121 from organization 100 for monitoring SCEs and to generate visualizations of safety critical element compliance. Discussed below in FIG. 4, characteristics of an organization and organization divisions, such as business units, locations, facilities, and organization parameters may be used and incorporated into management of assets, such as safety critical elements.

References to SCEs herein may be directed to components associated with production facilities, such as tanks, pumps, piping, pressure valves, shutdown systems, control systems, etc. It should be appreciated that the systems and methods described herein may be applied to other types of assets and are not limited to production facilities. As such, SCEs may include elements requiring monitoring by an organization.

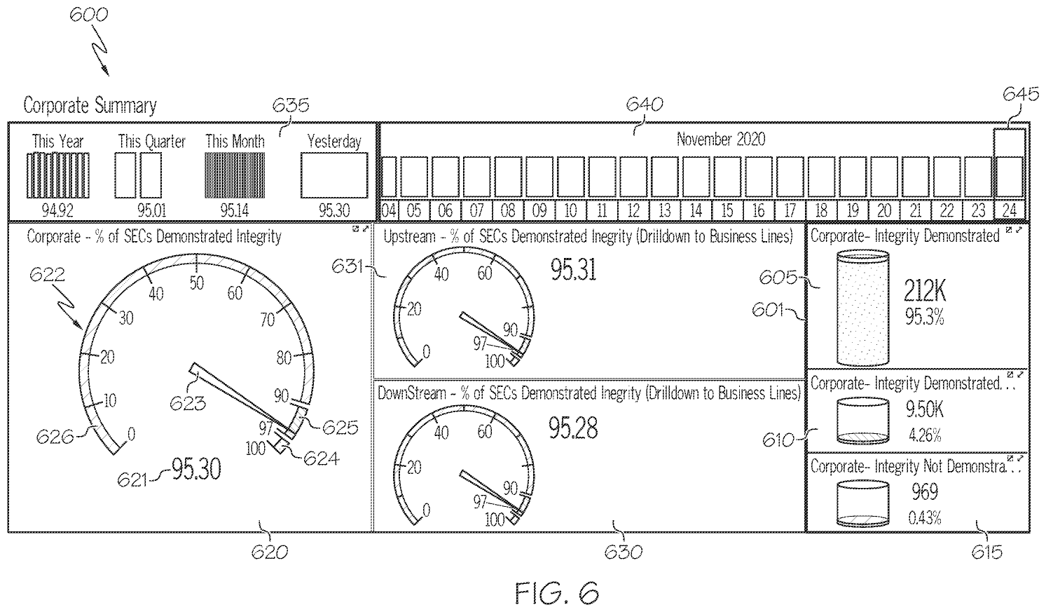

Asset integrity monitoring system 120 provides a scalable and customizable solution to address the integrity status of operations or industries having many assets. By way of example, monitoring assets for an organization can require fetching status from millions of data points for tasks scattered in different systems and activities including maintenance, inspection, quality assurance, and operation programs that are located in various applications and databases (i.e. SAP/PM, SAP/SAIF & SAP/OP, Integrity Operating Window (IOW), Emergency Shutdown (ESD) Bypass and other operational data). Systems and methods described herein can integrate data from many sources, determine status for elements of an entire organization, and generate visualizations including status determinations for decision makers of an organization (i.e. operators, foremen, supervisors, managers, etc.) for timely intervention to all activities intended to ensure safe operations. FIG. 1 illustrates end user devices 130₁₋ₙ that may access the integrity monitoring system 120 for status of safety critical elements. Systems and methods described herein provide visualizations that identify components and provide hierarchical arrangement and navigation of organization levels. Asset integrity monitoring system 120 may output visualizations to end user devices 130₁₋ₙ based on generated reports and using determinations of SCE compliance with integrity performance standards. Visualization output can include display configurations and formats, such as the visualizations shown in FIGS. 6-8 and 11, which include presentation of asset information in at least one display configuration. These visualizations can also provide drill down viewing of asset information for organization levels, based on hardware barriers, locations and/or SCE type. Asset integrity monitoring system 120 provides a dynamic solution that monitors and visualizes the integrity of the SCEs to ensure their functionality in preventing/mitigating major incidents.

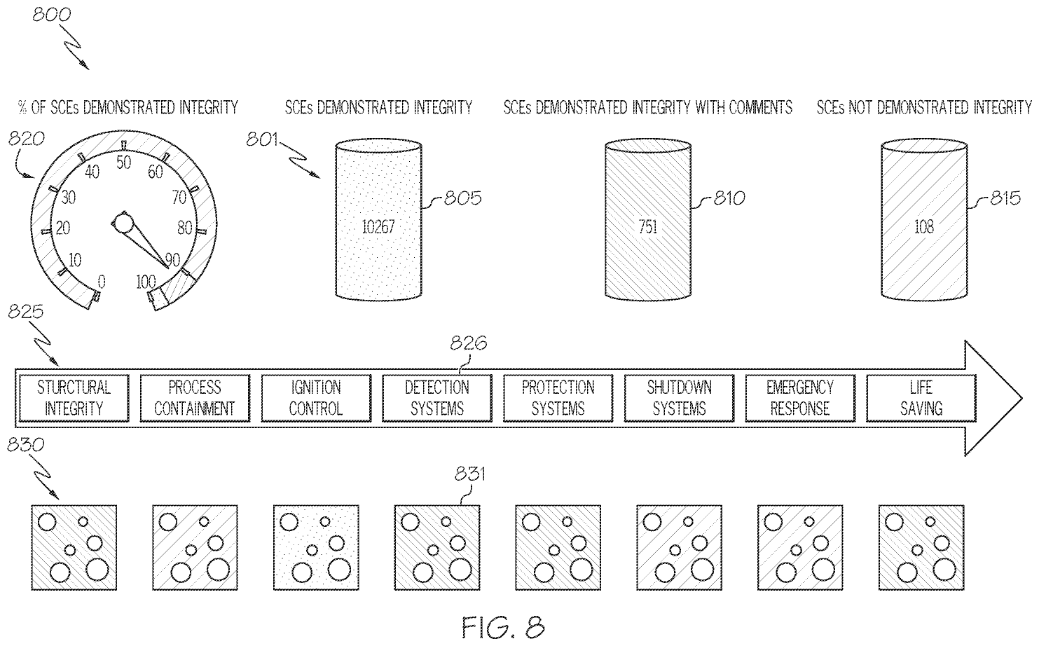

Embodiments utilize system components and integrate data into data records using an organization structure and safety critical element parameters. FIG. 1 illustrates a graphical representation of data 122 managed by asset integrity monitoring system 120 including data records 125₁₋ₙ for safety critical elements (e.g., SCEs 115₁₋ₙ, SCEs 116₁₋ₙ). Systems and processes herein use data records for each SCE. According to embodiments, each data record contains data for at least one organizational parameter, a hardware barrier parameter, and integrity performance standard. The data records can include organizational parameters for each layer of an organization structure. An example organizational structure is described in FIG. 4. Organization parameters in data records may be used for generating reports of safety critical assets. Similarly, hardware barrier classifications are provided for each SCE data record. Hardware barrier classifications allow for viewing organizational components based on the type of component. Classification by hardware barriers allows for monitoring and assessing components types of an organization or organization level. Hardware barrier classifications are described in FIG. 8. Integrity performance standards may be defined for each SCE to include one or more of verification tasks and inspection tasks required for each SCE. Each SCE can include multiple tasks to be performed. In addition to tasks, integrity performance standards may include the source identification for each source associated with a required task. The integrity performance standard can also include determinations of one or more statuses for each SCE. Example integrity performance standards are described in FIG. 10. According to embodiments, integrity performance standards can include a timing component for tasks to indicate a time period for performance of tasks. By way of example, SCEs may require testing performed on an annual basis of operation and verification of the task may require data from a plurality of sources. The asset integrity monitoring system can monitor performance of inspection and testing tasks within required time period to determine compliance.

According to embodiments, each SCE may be linked to an Integrity Performance Standard (IPS) by way of SCE data records. Data records of asset integrity monitoring system 120 can store a performance standard including a statement of the performance required of an SCE. The performance standard may be used as a basis for managing a hazard of major accidents. Performance standards can include a set of verification/assurance tasks that are retrieved from operational, inspection & maintenance practices for the SCE. Performance of tasks may be provided by multiple systems (e.g., SAP PM, SAP SAIF, PI, and Manual Operational Activities).

According to exemplary embodiments, asset integrity monitoring system 120 may be configured to interface with enterprise software applications to receive data. According to exemplary embodiments, a SAP PM data source may provide data for primary asset maintenance. According to another example, a SAP SAIF system may receive the status of equipment inspection records. In another example, plant information (PI) may contain the details of SCE components (e.g., for asset health monitoring) and may track performance against defined integrity operating window (IOW) limits. Asset monitoring results may be provided for analysis and shared with other systems for risk computation and analysis. According to another example emergency shutdown (ESD) bypass may track overrides of shutdown procedure. Asset integrity monitoring system 120 may require that equipment with preventive maintenance (PM) plans undergo a workflow in accordance with organization standards. SAP/PM workflows of specific PM plan related to SCE may provide data for asset integrity monitoring system 120. According to embodiments, asset integrity monitoring system 120 may generate to indicate completion of the PM plan timely with no findings to be corrected and thus trigger that the related IPS verification tasks are completed. Asset integrity monitoring system 120 may also determine completion of the PM plan timely with some findings to be corrected. By way of example, a malfunctioning notification or minor maintenance ticket (MMT) M4 notification may be raised to act on the findings to rectify. As a result a finding trigger that the related IPS verification tasks are completed but with further action. Asset integrity monitoring system 120 may also determine an overdue PM which can trigger that the related IPS verification task is not completed. Findings of asset integrity monitoring system 120 may result in status determinations. Status determinations for multiple SCEs may be presented in a visualization by way of metrics (e.g., percentages), graphics indicating compliance (e.g., digital gauges, etc.) and/or color coded output (e.g., Red for non-compliance, Yellow for needs attention and Green for compliance).

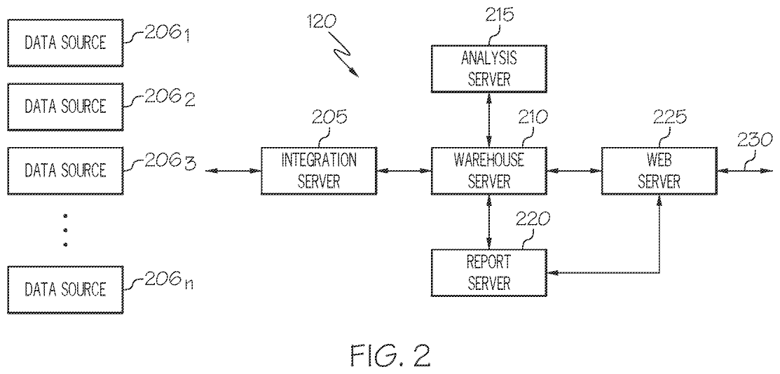

An analysis server, as described in FIG. 2, receives data from integration server 205 and updates an integrity performance standard for each safety critical element. Updating the integrity performance standard may include determining a status level for each safety critical element associated with the data records using a first status indicating completion of an inspection plan, a second status indicating completion of an inspection plan with at least one finding to be corrected, and a third status to indicate an incomplete safety plan. Systems and methods descried herein can provide visualizations of assets, asset status and asset compliance determinations across one or more levels of an organization and/or organizational hierarchy. In addition to indication of status levels, asset integrity monitoring system 120 can provide operations to ascertain integrity performance standard compliance and incomplete tasks. In addition to accounting for organization levels, business specific assets, and location, asset integrity monitoring system 120 allows for scalability to provide solutions for organizations of different sizes, for growth and changes to an organizational structure.

FIG. 2 illustrates a graphical representation of asset integrity monitoring system 120 according to embodiments. Asset integrity monitoring system 120 may be configured as a multi- tier solution to perform network services including back-end database storage, data warehousing, data analysis and reporting. Asset integrity monitoring system 120 includes integration server 205, warehouse server 210, analysis server 215, report server 220, and web server 225. Integration server 205 receives data from a plurality of data sources 206₁₋ₙ for a plurality of safety critical elements of an organization. Integration server 205 integrates data into asset integrity minoring system 120, links received data to SCEs of the organizational structure and outputs the data to warehouse server 210 and analysis server 215. SCEs can include at least one data source providing data for each SCE. In addition, each SCE includes an integrity performance standard requiring tasks that may require data from a plurality of sources to very task completion. As discussed herein, asset integrity monitoring system 120 may store integrity performance standards for SCEs in SCE data records.

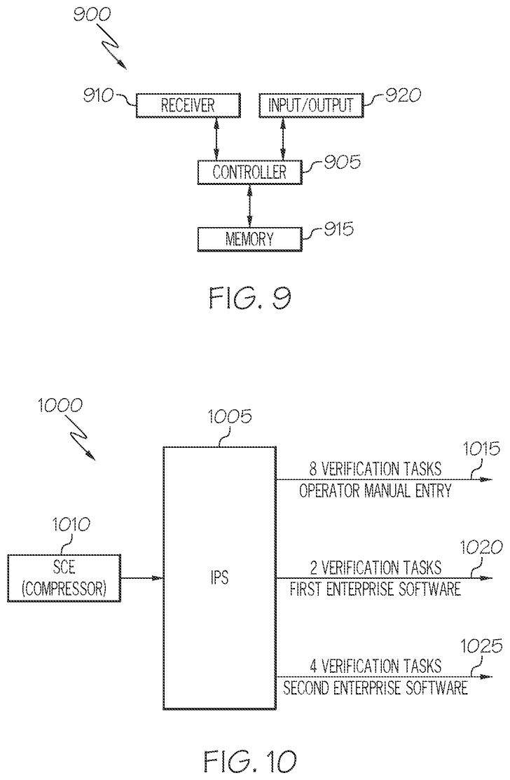

Asset integrity monitoring system 120 may configured with a network configuration including at least one server configured to interface with data sources 206₁₋ₙ. According to embodiments, asset integrity monitoring system 120 can include one or more servers and/or computing devices to perform functions of each server. An example computing device configuration for servers and devices of asset integrity monitoring system 120 is described below with reference to FIG. 9. According to embodiments, one or more functions of servers and/or asset monitoring system 120 may be combined.

Data sources 206₁₋ₙ include data sources and/or connections to one or more elements for obtaining SCE information. Data sources 206₁₋ₙ may include enterprise resources and enterprise software applications (e.g., SAP, OSI, etc.) for generating asset data, sources providing identification of manual operations (e.g., manual spreadsheet based maintenance logs, on-site inspection, etc.), emergency shutdown system (ESD) bypass data sources, and asset sources in general. Data sources 206₁₋ₙ can be configured to output updates to asset integrity monitoring system 120 periodically (e.g., daily, weekly, etc.) and/or when updates to assets are generated. Data sources 206₁₋ₙ may be spread among facilities. In embodiments, data sources may collect data from one or more facilities or locations based on the type of data collected. Asset integrity monitoring system 120 maybe configured to receive data from data sources 206₁₋ₙ to evaluate tasks of integrity performance standards and thus, asset integrity monitoring system 120 may collect and integrate data from a variety of sources to evaluate SCEs. According to an exemplary embodiment, asset integrity monitoring system 120 includes integration server 205 to receive data from at least one of an enterprise resource report, plant data source, maintenance log, emergency shutdown bypass system, and manual report. These reports may be generated for SCEs associated in one or more locations. Data may be received from data sources in a plurality of locations.

According to embodiments, asset integrity monitoring system 120 uses data source types defined based on available data sources for SCEs and available connections. Data records may identify SCE task sources of asset integrity monitoring system 120 and link the data records with available data using a data source type table. Each task may be linked by a data source ID (if applicable—i.e. PI/BYPASS) and other values for the task may be pulled from received data using associated equipment identification. Asset integrity monitoring system 120 can receive and/or pull data from defined data sources. Received data may be stored into by integration server 205 using temporary tables (Manual Statuses, SAP Overdues, SAP Notifications, PI Readings, Bypass Statuses, etc.). Once all the task statuses are being collected into temporary table, an integrity calculation may be initiated to calculate the integrity at each level of organizational hierarchy (e.g., Company, Business Line, Admin Area, Department, Facility, Unit, and Equipment).

According to embodiments, integration server 205 may be configured as an integration platform and may provide hosting services to communicate with data sources 206₁₋ₙ. Integration server 205 is configured to receive data from a plurality of data sources 206₁₋ₙ for a plurality of SCEs of the organizational structure. Integration server 205 may receive data from data sources 206₁₋ₙ for one or more facilities or locations of an organization. In certain embodiments integration server 205 may receive data for an SCE from two different data sources. Received data may be in the in the form of reports which may include indications of task completion, such as a completed maintenance task. Data sources 206₁₋ₙ may also provide inspection reports, such as in person inspections. In other embodiments, data sources 206₁₋ₙ may output indications of an in person visual inspection and/or in person maintenance tasks. Data sources 206₁₋ₙ may also provide identifiers of the data sources with transmitted data. Received data may also include SCE metadata to identify maintenance tasks or tasks in general performed for an SCE. In embodiments data sources 206₁₋ₙ may also provide an identifier for each SCE with transmitted data. Integration server 205 links received data to safety critical elements of the organizational structure. In embodiments, asset integrity monitoring system 120 includes a data record for each SCE, the data record storing an identifier of the SCE and an identifier for each source needed to validate an integrity performance standard. For example, each data record can include data source identifiers for data sources responsible for providing task data for the SCE. Integration server 205 may be configured as a middleware platform to provide an integration engine and integration functions, and to communicate with different receive ports to receive incoming data. Integration server 205 may also be configured to link received data with data records of asset integrity monitoring system 120 and output data and any associations to warehouse server 210 and analysis server 215. In embodiments, integration serve 205 may store linked data in temporary files to be combined with data records for SCEs by warehouse server 210.

Warehouse server 210 stores data received from integration server 205 into data records for SCEs. Each safety critical element data record includes at least one organizational parameter, a hardware barrier parameter and integrity performance standard. Warehouse server 210 scan update the data record for each SCE with a temporary data record received from integration server 205. Warehouse server 210 also stores performance standard determinations of analysis server 215 into data records of safety critical elements with at least one of a second status and third status. Warehouse server 210 may provide data mart services for exchange with analysis server 215.

Analysis server 215 receives the data from integration server 205 and updates an integrity performance standard for each safety critical element associated with the data. As discussed in FIG. 10, each SCE includes an integrity performance standard requiring tasks to be performed for the SCE. When a task is performed for the SCE, the asset integrity monitoring system 120, and in particular, analysis server 215 determines whether a task is complete, whether a task has not been complete, and/or an override of a task, such as a bypass of an emergency shutdown. Updating of an integrity performance standard can include updating a data record to indicate that a data source has provided data of a source. By way of example an SCE may require data from multiple sources to determine completion of a task. Maintenance requirements of SCEs may be defined as a task, and similarly inspection of an SCE may be a task. Tasks for an SCE can include validation of performance within a particular range. To validate SCEs, asset integrity monitoring system 120 may rely on a combination of enterprise software for generating output indicating operation in an acceptable range. Completion of all tasks for an SCE within the require timeframe for task completion may be considered completion of an inspection plan, completion of a maintenance plan, and/or completion of the integrity performance standard. In addition to performance, SCEs may include an operating life or time period where the SCE requires replacement. Replacement of the SCE may satisfy a task of the integrity performance system. In certain embodiments, tasks may be created for one or more of replacing and repairing an SCE. As such, data received by integration server 205 may indicate that an SCE requires service and/or replacement. Updating the integrity performance standard includes determining a status level for each safety critical element associated with the data records using a first status indicating completion of an inspection plan, a second status indicating completion of an inspection plan with at least one finding to be corrected, and a third status to indicate an incomplete safety plan. With respect to the first status, completion of the inspection plan may include completion of all maintenance and verification of operation of the SCE. The second status may relate to conditions of acceptable operation, however requirements of SCE maintenance, awaiting additional data and/or requiring follow-up action to an SCE may be marked as a second status. As such, the second status may indicate an acceptable operational status for an SCE. The third status may be used to indicate that an integrity performance standard is not being met for an SCE. Analysis server 215 outputs each performance standard determination for safety critical elements with at least one of a second status and third status to warehouse server 210. Warehouse server 210 may be configured to store a data record for each safety critical element. According to embodiments, each safety critical element data record includes a plurality of organizational parameters for the organizational structure, a hardware barrier parameter classifying a safety critical element within a predetermined set, and integrity performance standard particular to the data record based on safety critical element type and function. Warehouse server 210 may also store updated statuses. In embodiments, warehouse server 210 does not receive first status indications to alleviate data throughput. However, verifications of received data and completed integrity performance standards may be stored in SCE data records. With respect to second and third status indications, warehouse server 210 may store the indications with a data record to indicate attention needed to an SCE and/or track compliance issues with respect to an SCE. Warehouse server 210 may be a data warehouse server provided SQL data for analysis server 215 to process received data by way of MOLAP (Multi-Dimensional Analytical Processing).

Report server 220 is configured to generate a report for the organizational structure using the performance standard determinations for safety critical elements determined by analysis server 215, data stored by warehouse server 210, and safety critical element data records for the organization. The report is generated to identify safety critical elements with the first status, the second status, and the third status. Web server 225 is configured to output the report, output shown as 230, to at least one device (e.g., devices 130₁₋ₙ) as a graphical visualization of operational status of safety critical elements across the organizational structure. The graphical visualizations are configured to present safety critical elements using at least one of an organizational parameter and a hardware barrier parameter. Report server 220 may also be configured to determine compliance determinations for SCEs across levels of an organization, hardware barrier and/or based on selection of a visualization. By way of example, report server 220 may determine the percentage of SCEs for each status level including a representation, such as a percentage, graphical display element or gauge showing the amount of compliance for SCEs. Compliance measures, which are separate from received data, may be determinations that allow a user insight into compliance for an entire organization or an organization level. An example compliance measure provided by report server 220 may include the percentage of SCEs that are in compliance with a first status. As such, the compliance measure can provide an indication of SCEs that are not in compliance.

According to embodiments the compliance measure may be a percentage of SCEs with a first status or second status. According to embodiments, report server 220 is a reporting platform that connects to warehouse server 210 to read data records and generated visualizations using SCE data records. Web server 225 may provide a web based application that operates as a secured container for visualizations output as 230. Web server 225 may provide visualizations as one or more of dashboards, reports and displays to present to data records for SCEs, compliance, and status determinations. Web server 225 may also direct and/or output visualizations of SCE compliance based on user credentials, such as AIMS administrators and Users.

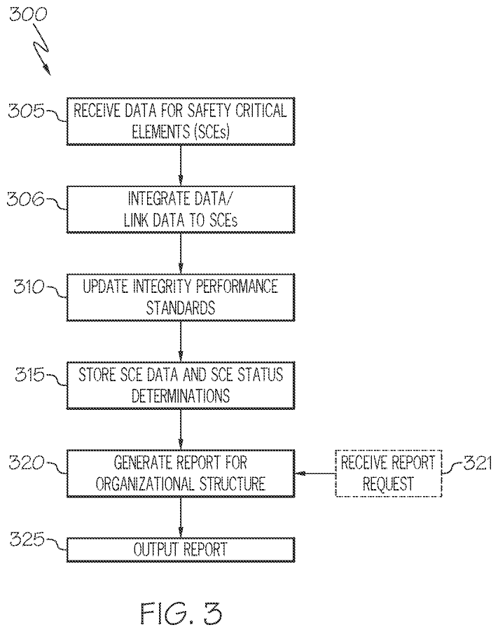

FIG. 3 illustrates process 300 for status monitoring of safety critical elements. Process 300 may be performed for monitoring safety critical elements of an organizational structure, such as a corporation or business having one or more facilities and one or more locations. With organizational structures with production capabilities, monitoring of assets, and especially safety critical elements, is required to ensure production and limit losses. Process 300 may be performed by one or more elements of asset integrity monitoring system 120, including but not limited to integration server 205, warehouse server 210, analysis server 215, report server 220, and web server 225.

Process 300 may be initiated by receiving data for safety critical elements (SCEs) at block 305. Data for SCEs may be received from a plurality of data sources for a plurality of SCEs of the organizational structure. According to embodiments, integration server 205 receives data from at least one of an enterprise resource report, plant data source, maintenance log, emergency shutdown bypass system, and manual report. Integration server 205 can receive data from data sources in a plurality of locations, such as a first facility in a first location and a second facility in a second location. Received data can include collections of tasks performed for SCEs.

Received data may be integrated and linked to SCEs at block 306. Integration server 205 can link received data from the plurality of data sources using source identifiers for the data sources to data records for safety critical elements. Each SCE data record may be configured to identify data sources for integrity performance standards. Data sources may also provide data for a plurality of SCEs. Data records for each SCE may identify an SCE, sources for the SCE, at least one parameter for organizational levels associated with the SCE, and at least one safety barrier. In embodiments, received data is linked to safety critical elements of the organizational structure using temporary storage files. At block 306, integration server 205 may extract at least one SCE identifier and task information from received data. For SCE identifier in received data, task information and a source identifier for the task information may be stored in a temporary file. Integration of data by integration server my include storing a plurality of task updates for each SCE. Updates may be stored in a temporary file to allow for task updates and SCE data to be combined with a stored data record having previous updates.

According to embodiments, data records for SCEs may be generated and/or defined using templates to include parameters for one or more levels of an organizational structure, hardware barriers and SCE identification. At block 306, integrating and linking of received data may be performed using one or more parameters of the data records including using identifiers for sources and identifiers for SCE. After linking, received data may be used to assess integrity performance standards for particular SCEs.

At block 310 interiority performance standards for SCEs may be updated using received data. Updating integrity performance standards can including determining a status for each SCE with received data. Determining a status level for each safety critical element at block 310 can include determination of at least one of a first status indicating completion of tasks of an integrity performance standard or inspection plan, a second status indicating completion of integrity performance standard with at least one finding to be corrected, and a third status to indicate an incomplete integrity performance standard, where one or more tasks needs to be performed.

Each SCE may be defined to include an integrity performance standard including at least one task to monitor the SCE. Tasks can include data generated from enterprise software, data generated form manual inspection, and tasks associated with operation of an SCE, such as maintenance required after use for a period of time. Similar SCEs may be configured using a template to identify tasks for each SCE, and tasks can be defined for particular SCEs. In an exemplary embodiment, an integrity performance standard for an SCE can include sets of verification/quality assurance tasks that are retrieved from operational, inspection & maintenance applications (i.e., SAP/PM, SAP/SAIF & SAP/OP, Integrity Operating Window (IOW), Emergency Shutdown (ESD) Bypass and other operational data). Integrity for the standard may be demonstrated, demonstrated with comments, or identified as not demonstrated. Analysis server 205 can implement an integrity performance standard for each safety critical element associated based on received data. By way of example, analysis server 215 may be configured to update integrity performance standards for SCEs having received data. SCEs without received data may not be updated to provide efficient processing. Analysis server 215 can utilize data from integration server 205, such as a temporary data record, to determine task completion, such as completion of a maintenance task and/or inspection of a safety critical element inspection.

Analysis server 215 can update the integrity performance standard, and in particular status of an SCE, by determining a status level for each safety critical element associated with the data records. Status determinations may be utilized to provide graphical indicators of SCE status in graphical visualizations. By way of example, a first status may relate to a characterization for equipment in a Green Zone (e.g., green status), a second status in a Yellow zone (e.g., yellow status), and a third status in a Red zone (e.g., red status). Analysis server 215 can output each performance standard determinations for safety critical elements with at least one of a second status and third status to warehouse server 210 at block 310. In certain embodiments, output of a second status or third status can reduce updating of SCE data records. In addition, second and third status determinations can be output as a report or list to indicate incomplete tasks of integrity performance standards.

At block 315, SCE data and status determinations ate stored by warehouse server 215. According to embodiments, warehouse server 215 can store data received from the integration server into data records for safety critical elements. Each safety critical element data record includes at least one organizational parameter, a hardware barrier parameter and integrity performance standard. Warehouse server 215 stores performance standard determinations of the analysis server into data records of safety critical elements with at least one of a second status and third status.

At block 320, a report for an organization structure may be generated. The report for the organizational structure may be generated using the performance standard determinations for safety critical elements determined by the analysis server, data stored by the warehouse server, and safety critical element data records for the organization. The report can identify safety critical elements with the first status, the second status, and the third status. Obtaining usable information for a large organization is necessary. Accordingly, visualizations of SCE data records and statuses can be provided with a plurality of configurations as described in FIGS. 6-8 and 11 below. A report for an organization may include data to generate one or more visualizations. Reports generated at block 320 may be generated based on one or more requests received at optional block 321. Users of asset integrity monitoring system 120 may request views of SCEs for a particular level of an organization, hardware barriers and/or the organization as a whole. Generated reports at block 320 may include determining percentages compliance for SCEs based on an organizational level or desired presentation format. For example, for a requested presentation of an entire organization, the visualization may present metrics including percentages for SCEs in compliance for the entire organization in addition to compliance percentages for SCEs with each status. Generated reports may also include percentages of SCEs in compliance for each hardware barrier and/or based on an organizational level. Generated reports may also determine compliance percentages for SCEs using status determinations and parameters of data records. According to embodiments, visualizations can include compliance percentages for a SCE type for at least one of a location, facility, organizational level, hardware barrier and time period.

At block 325, reports may be output to one or more devices. Web server 225 may output reports to at least one device as a graphical visualization of operational status of safety critical elements across the organizational structure. The graphical visualization may be configured to present safety critical elements using at least one of an organizational parameter, and a hardware barrier parameter. Report server 220 may be configured to output a compliance value of safety critical elements for the organization, a compliance value of safety critical elements for the first status, a compliance value of safety critical elements for the second status, and a compliance value of safety critical elements for the third status. Alternatively, report server 220 outputs a compliance value of safety critical elements for the organization, and at least one compliance value for a selected organizational parameter, wherein the at least one compliance value for a selected organizational parameter is presented as graphical display elements.

FIG. 4 illustrates a graphical representation of an exemplary organization structure. Systems and methods described herein allow for an organizational hierarchy as well as asset characteristics to be associated with each SCE. Organizational structure 400 is an example of a multi-tiered hierarchy providing multiple organization levels including company level 401, business line level 402, Administrative Area level 404, Department level 404, facility level 405, unit level 406 and SCE level 407. According to embodiments, organizational structure 400 includes a single company level 401 as the top level of the organization, where other levels can multiple instances or branches per level of the hierarchy. According to embodiments, business line level 402 may relate to a business operation of the organization. Administrative Area level 404 may relate to a management components and department level 404 may relate to a department within the administrative level 404. Facility level 405 may relate to a location or production facility housing a plurality of SCEs. Unit level 406 may relate to a unit of a facility, such as a production machine/machines, section of the facility and SCE level 407 represents a safety critical element type. Levels of organizational structure 400 are exemplary, and it should be appreciated that additional or fewer organization levels may be utilized in the systems and methods described herein. Organizational levels may allow for presentation of reports as visualizations and for drill down elements to identify sources of non-compliance relative to the organizational structure as a whole. According to embodiments, a data record for an SCE may include a stored parameter for each level of the organization hierarchy, such as levels company level 401, business line level 402, Administrative Area level 404, Department level 404, facility level 405, unit level 406 and SCE level 407. Embodiments described herein can utilize one or more levels for an organization and are not limited to the levels illustrated in FIG. 4.

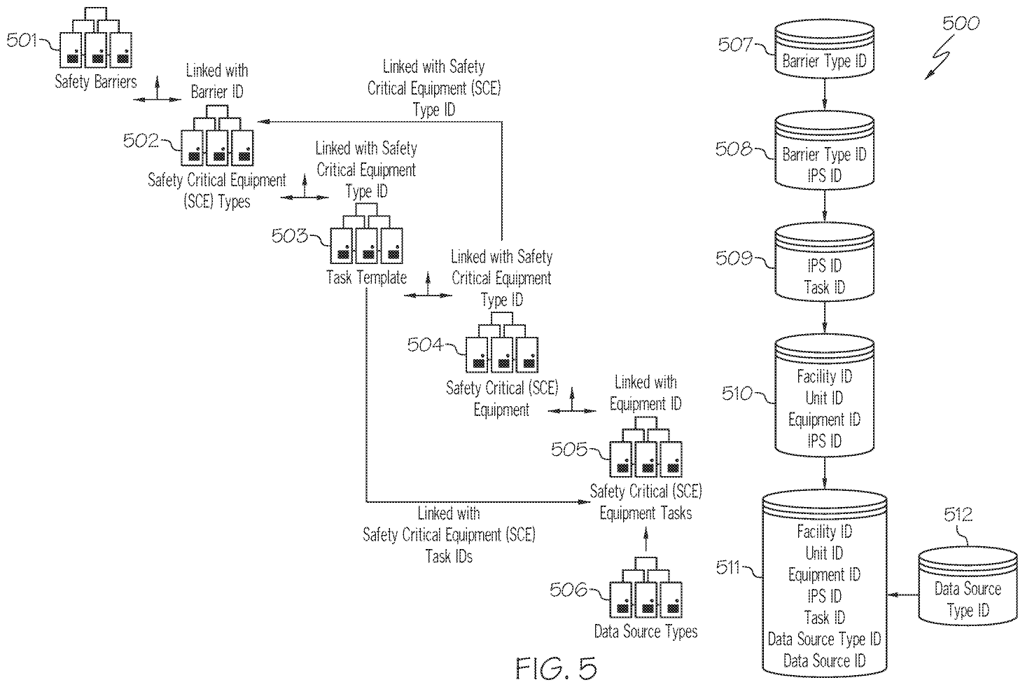

FIG. 5 illustrates a graphical representation of template 500 for an organizational hierarchy and asset definitions templates. According to embodiments, each SCE data record may be based on a template including parameters for a safety barrier and parameters based on SCE type. Use of a template allows for similar SCEs to be integrated into a system for management. The template can also allow for associating tasks and data sources to an SCE. Similar SCEs may require similar maintenance, inspection and monitory. Use of a template and template parameters simplifies application to SCEs of an organization and can also allow for modification of particular tasks to characteristics for an SCE. Parameters of template 500 may be stored as an asset definition. By way of example, the asset integrity monitoring system may store parameters for each level of template 500 for each SCE. Template 500 is an exemplary AIMS template which may be configured for each SCE. Template 500 may be used to generate a data record and for setting an integrity performance standard for each SCE.

According to embodiments, template 500 includes parameters for safety barriers 501, SCE equipment type 502, task template 503, SCE identification 504, SCE tasks 505 and data source types 506. Safety barriers 501 provides a safety barrier classification for an SCE. The categories of safety barriers (e.g., hardware barriers) may include Structural Integrity, Process Containment, Ignition Control, Detection Systems, Protection Systems, Shutdown Systems, and Emergency Response and Life Saving. Each barrier may be represented as a single hardware entity, each barrier may be representative of a group of SCEs that actually form the physical barrier. For example, a process containment barrier may include Pressure Vessels, Heat Exchangers, Rotating Equipment, Tanks, Piping Systems, Pipelines, Relief System, etc. All of these individual SCEs serve the same integrity purpose of maintaining process containment and are thus, grouped together into one barrier. Hardware safety barriers are described in FIG. 8.

SCE equipment type 502 provides the type of equipment associated with an SCE, which can depend on the organization. SCEs for productions facilities can include pumps, pressure vessels, storage tanks, piping systems, relief vents, shutdown systems, controls, etc. Task templates 503 provides tasks that can be associated to an SCE. Similar SCEs may have similar tasks, however, tasks for each SCE may be defined. SCE identification 504 allows for each SCE to be individually and uniquely numbered within asset integrity monitoring system 120. Embodiments link SCE identification 504 to SCE types 502 for use in generating visualizations of asset compliance. SCE tasks 505 allows for tasks to be defined for a particular SCE. Task templates 503 may be linked SCE tasks 505 to pull tasks to SCE tasks 505. Template 500 also includes data source types 506 to allow for data sources to be assigned to each SCE.

FIG. 5 also shows an asset definition process for SCEs. According to embodiments, assets or SCEs may include data records that may be defined and used by asset integrity monitoring system to monitoring SCEs, integrate data and generate visualizations. Using template 500, asset integrity monitoring system 120 assigns barrier type 507 to a data record for an SCE. Barrier type will be assigned based on the type of SCE at block 507. For example, sensors may be assigned to a barrier type for detection systems. Barrier type ID may be defined at block 507 in the parameter for safety barriers 501 of template. At block 508, identifiers for barrier type (e.g., barrier type ID) and integrity performance standard (IPS ID) may be linked. As such, an SCE data record includes an association with a barrier type and an integrity performance standard. At block 509, task may be linked to the integrity performance standard. As such, one or more tasks may be assigned to an integrity performance standard for an SCE. At block 510 organizational parameters may be assigned to a data record including assigning at least one of a facility identifier, unit identifier, and equipment identifier to the integrity performance standard. As a result the data record includes a particular identification number for an SCE and parameters identifying at least one level of an organization. At block 511, the data record may be associated with at least one data source identifier and at least one data source type identifier. Data source type identifiers may be determined at block 512 using available data sources. Data records determined by the asset definition process may be utilized and modified by asset integrity monitoring system 120.

FIG. 6-8 illustrate visualizations of for status monitoring safety critical elements. Visualizations as described herein include output of status determinations for from one or more levels of an organization, such as a top level (corporate, company, etc.) down to an equipment level. In addition to organization levels, visualizations can provide determinations for SCE equipment based on hardware barriers, location and/or equipment type. Visualizations, and components of the visualizations, in FIGS. 6-8 may be presented as interactive displays. For example, display elements may be presented based on a request for compliance values of the organization based on one of an organizational parameter, and a hardware barrier parameter.

FIG. 6 illustrates visualization 600 for status monitoring of safety critical elements of the organization. Visualization 600 includes display panel 601 for SCE status. Display panel 601 includes display element 605 for SCEs of the organization according to a first status, display element 610 for SCEs of the organization according to a second status, and display element 615 for SCEs of the organization according to a third status. Display elements 605, 610 and 615 each include a graphical element representing an amount of SCEs for the organization within a status, numerical representation of an amount of SCEs and percentage of SCEs for the status. Compliance values for visualization 600 may be based on determinations of report server 222. By way of example, display elements 605, 610 and 615 may be presented using a compliance value of safety critical elements for the first status, a compliance value of safety critical elements for the second status, and a compliance value of safety critical elements for the third status, respectively. By providing representations of SCEs meeting integrity performance standards, SCEs for the organizational level may be monitored. Visualizations can also include additional display elements for navigation and/or representation of SCE status.

In FIG. 6, visualization 600 includes an overall indication of SCE compliance in display gauge 620. Display gauge 620 provides a graphical representation for all SCEs of the organizational level, in visualization 600 that is all SCEs, and as such provides an additional graphical for an entire organization. Display gauge 620 includes percentage display 621 and a reference element 622. Reference element 622 includes dial 623 to illustrate percentage display 621 relative to reference element 622. Reference element 622 includes display portions 626, 627, and 628 to represent percentage values along reference element 622. Display portions 626, 627, and 628 to may represent uncompliant, needing attention, and compliant zones, respectively.

According to embodiments, visualization 600 includes display gauge 630 to present compliance percentage for downstream SCEs and display gauge 631 to present compliance percentage for downstream SCEs. Visualization 600 can include display window 635 for selection of SCE compliance data for current and past time periods including yearly, quarterly, monthly and even daily time periods, such as a previous day. Representation of visualization 600 may relate to determinations for a current day. Visualization 600 can also include display window 640 for selection of a particular day, with highlight element 645. As previously indicated graphical elements of visualization may be interactive to allow for selection of organizational layers and previous determinations.

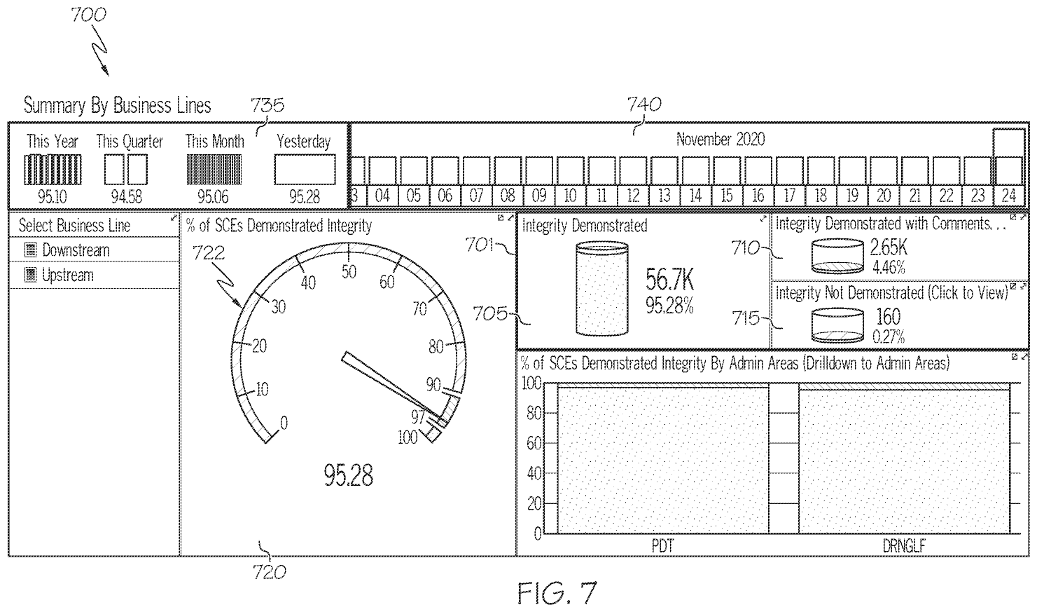

FIG. 7 illustrates a visualization for status monitoring of a selected organizational level. Visualization 700 is an exemplary representation of a report for a level of an organization, such as a business line. Visualization 700 includes display panel 701 for SCE status and to output a compliance value of safety critical elements for the organization. Display panel 701 includes display element 705 for SCEs of the organization level according to a first status, display element 710 for SCEs of the organization level according to a second status, and display element 715 for SCEs of the organization level according to a third status. Display elements 705, 710 and 715 each include a graphical element representing an amount of SCEs for the organization within a status, numerical representation of an amount of SCEs and percentage of SCEs for the status. Compliance values for visualization 700 may be based on determinations of report server 222. By way of example, display elements 705, 710 and 715 may be presented using a compliance value of safety critical elements for the first status, a compliance value of safety critical elements for the second status, and a compliance value of safety critical elements for the third status, respectively. By providing representations of SCEs meeting integrity performance standards, SCEs for the organizational level may be monitored. Visualizations can also include additional display elements for navigation and/or representation of SCE status.

In FIG. 7, visualization 700 includes an overall indication of SCE compliance in display gauge 720 for the organizational level. Display gauge 720 may provide a compliance value for a selected organizational parameter presented as graphical display elements. Display gauge 720 provides a graphical representation for all SCEs of the organizational level, in visualization 700 that is all SCEs of a business line. Display gauge 670 includes percentage display and reference element 722 to illustrate percentage display. Visualization 700 can also include display window 735 for selection of SCE compliance data for current and past time periods and display window 740 for selection of a particular day. Although visualization 700 is described as a business line presentation, it should be appreciated that the organizational level and display format may apply to other organizational levels, such as that of a facility.

FIG. 8 illustrates visualization 800 for status monitoring SCEs associated with hardware barriers. Visualization 800 is an exemplary representation of a report for hardware barrier visualization. According to embodiments, asset integrity management system 120 can include generating reports that visualize the integrity status of each SCE which provides the operational personnel with daily view of the risk level at their facilities and required actions so they act promptly prior to any incident or asset failure so that they ensure the facility risk is mitigated to As Low As Reasonably Practicable (ALARP). Hardware Barriers may be classifications of SCEs and can be used to visualize a series of control measures or barriers, which either prevent the hazard from being realized, or limit the effects of the accident.

FIG. 8 illustrates visualization 800 for status monitoring of safety critical elements of the organization. Visualization 800 includes display panel 801 for SCE status using output of report server 222 based on compliance values of safety critical elements for an organization, and at least one compliance value for hardware barrier parameters. Display panel 801 includes display element 805 for SCEs of the organization according to a first status, display element 810 for SCEs of the organization according to a second status, and display element 815 for SCEs of the organization according to a third status. Display elements 805, 810 and 815 each include a graphical element representing an amount of SCEs for the organization within a status, numerical representation of an amount of SCEs and percentage of SCEs for the status. Compliance values for hardware barrier parameters of visualization 800 may be based on determinations of report server 222. By way of example, display elements 805, 810 and 8615 may be presented using a compliance value of safety critical elements for the first status, a compliance value of safety critical elements for the second status, and a compliance value of safety critical elements for the third status, respectively. By providing representations of SCEs meeting integrity performance standards, SCEs for the organizational level may be monitored. Visualizations can also include additional display elements for navigation and/or representation of SCE status.

In FIG. 8, visualization 800 includes an overall indication of SCE compliance in display gauge 820. Display gauge 820 provides a graphical representation for all SCEs of the organization. Visualization 800 includes display of hardware barriers 825 by way of a labeled graphical elements, such as graphical element 826 labeled detection systems. Visualization 800 can also include graphical elements 830 which may provide status for each hardware barrier. Graphical elements 830 may be presented with color to signify status, such as green for compliance, yellow for compliant need attention and red for non-compliance. Display element 831 provides status for the hardware barrier (e.g., detection systems) associated with graphical element 826. Visualization may be generated for each organizational level and may be presented by linking inking safety barriers with SCEs. It should be appreciated that safety barriers in FIG. 8 are exemplary. Classification by barrier type may aide in presenting integrity status at different levels of organizational hierarchy.

FIG. 9 illustrates a server configuration according to embodiments. Servers of integrity monitoring system 120 may include one or more components. FIG. 9 depicts a graphical representation of server 900 which may be a device configured process data for SCEs and generate visualizations. Server 900 may be part of a system, such as asset integrity monitoring system 120. Server 900 may be configured to receive data from a plurality of sources, and/or or other system servers, for at least one of data integration, data analysis and report generating. According to embodiments, device 900 includes controller 905, receiver 910, memory 915 and input/output block 920.

Controller 905 may relate to a processor or control device configured to execute one or more operations stored in memory 915, such as processes for SCEs. Controller 905 may be configured to perform one or more processes herein including process 300 of FIG. 3.

Controller 905 may be coupled to memory 915, I/O 920 and receiver 910. Controller 905 may be configured to control operations based on one or more inputs from I/O block 920.

FIG. 10 illustrates a graphical representation of integrity performance standard 1000 for safety critical elements. Integrity performance standard 1000 can require tasks 1005 for each SCE, such as SCE 1010. Data for each SCE, such as SCE 1010, may be used to evaluate tasks 1005. Integrity performance standard 1000 may require a plurality of tasks from one or more sources. Tasks 1005 include tasks 1015, tasks 1020, and tasks 1020. According to an exemplary embodiment, tasks 1015 include verification tasks based on operator manual entry, tasks 1020 are verification tasks from first enterprise software and tasks 1025 includes task from a second enterprise software. Assurance tasks in may be related to enterprise software (e.g., SAP).

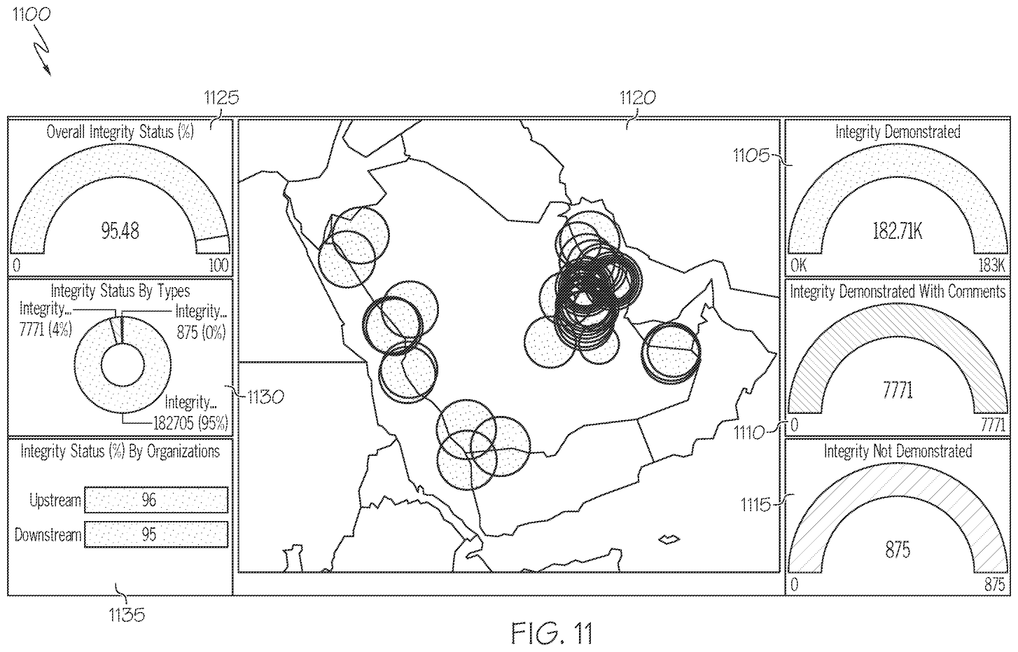

FIG. 11 illustrates visualization 1100 of for status monitoring of safety critical elements including a geographic representation. Visualization 1100 is an exemplary representation of a report for SCEs with status indicators and geographic location of facilities. Visualization 1100 includes display panel for SCE status including display element 1105 for SCEs of the organization according to a first status, display element 1110 for SCEs of the organization according to a second status, and display element 1115 for SCEs of the organization according to a third status. Display elements 1105, 1110 and 1115 each include a graphical element representing an amount of SCEs for the organization within a status, numerical representation of an amount of SCEs and percentage of SCEs for the status. Compliance values for visualization 1100 may be based on determinations of report server 222.

In FIG. 11, visualization 1100 includes a geographic representation for locations of SCEs and an overall indication of SCE compliance by display element 1125. Display gauge 1130 provides compliance percentage of SCEs by type. Display gauge 1135 provides compliance percentage of SCEs by organization (e.g., organizational level).

For the purposes of describing and defining the present invention it is noted that the terms “about” and “approximately” are utilized herein to represent the inherent degree of uncertainty that may be attributed to any quantitative comparison, value, measurement, or other representation. The terms “about” and “approximately” are also utilized herein to represent the degree by which a quantitative representation may vary from a stated reference without resulting in a change in the basic function of the subject matter at issue.

For the purposes of describing and defining the present invention, it is noted that reference herein to a calculation or other determination being a “function of” a value, parameter, variable, or other construct, is not intended to denote that the determination is exclusively a function of the listed value, parameter, variable, or other construct. Rather, reference herein to a determination that is a “function of” a listed construct is intended to be open ended such that the determination may be a function of a single construct or a plurality of constructs.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the terms “in which” and “wherein” as transitional phrases. For the purposes of defining the present invention, it is noted that these terms are introduced in the claims as an open-ended transitional phrase that is used to introduce a given number of claim elements and should be interpreted in like manner as the more commonly used open-ended preamble term “comprising.”

What is claimed is:

1-20. (canceled)

21. An asset integrity management system for monitoring safety critical elements of an organizational structure, the system comprising an integration server, an analysis server, a warehouse server, a report server, and a web server, in which:
the integration server receives data from a plurality of data sources for a plurality of safety critical elements of the organizational structure, links received data to safety critical elements of the organizational structure, and outputs the data to the analysis server and the warehouse server;
the warehouse server stores data received from the integration server into data records for safety critical elements, wherein each safety critical element data record includes at least one organizational parameter, a hardware barrier parameter and integrity performance standard;
the analysis server receives the data from the integration server and updates an integrity performance standard for each safety critical element associated with the data, wherein updating the integrity performance standard includes determining a status level for each safety critical element associated with the data records using a first status indicating completion of an inspection plan, a second status indicating completion of an inspection plan with at least one finding to be corrected, and a third status to indicate an incomplete safety plan;
the analysis server outputs each performance standard determination for safety critical elements with at least one of a second status and third status to the warehouse server;
the warehouse server stores performance standard determinations of the analysis server into data records of safety critical elements with at least one of a second status and third status;
the report server is configured to generate a report for the organizational structure using the performance standard determinations for safety critical elements determined by the analysis server, data stored by the warehouse server, and safety critical element data records for the organization, the report identifying safety critical elements with the first status, the second status, and the third status; and
the web server configured to output the report to at least one device as a graphical visualization of operational status of safety critical elements across the organizational structure, the graphical visualization configured to present safety critical elements using at least one of an organizational parameter, and a hardware barrier parameter.

22. The system as claimed in claim 21 wherein the integration server receives data from at least one of an enterprise resource report, plant data source, maintenance log, emergency shutdown bypass system, and manual report, and wherein the integration server receives data from data sources in a plurality of locations.

23. The system as claimed in claim 21 wherein the integration server links received data from the plurality of data sources using source identifiers for the data sources, and wherein each safety critical element data record identifies data sources for integrity performance standards.

24. The system as claimed in claim 21 wherein the analysis server updates integrity performance standards for each safety critical element associated with received data, the integrity performance standards including at least one verification task defined for each safety critical element, wherein the analysis server uses data determined by the integration server to determine task completion and status level.

25. The system as claimed in claim 21 wherein the analysis server outputs determinations for the second status and the third status with identification of incomplete tasks of integrity performance standards.

26. The system as claimed in claim 21 wherein the warehouse server stores a data record for each safety critical element, wherein each safety critical element data record includes a plurality of organizational parameters for the organizational structure, a hardware barrier parameter to classify safety critical elements, and an integrity performance standard for the data record based on safety critical element type.

27. The system as claimed in claim 21 wherein the report server outputs a compliance value of safety critical elements for the organization, a compliance value of safety critical elements for the first status, a compliance value of safety critical elements for the second status, and a compliance value of safety critical elements for the third status.

28. The system as claimed in claim 21 wherein the report server outputs at least one compliance value for a selected organizational parameter, wherein the at least one compliance value for a selected organizational parameter is presented using data records for safety critical elements.

29. The system as claimed in claim 21 wherein the report server outputs at least one compliance value for hardware barrier parameters, wherein the at least one compliance value for hardware barrier parameters includes graphical display elements indicating status for each hardware barrier.

30. The system as claimed in claim 21 wherein the web server is configured to output the report as an interactive display, wherein display elements of the interactive display are presented based on compliance values of the organization, an organizational parameter, and a hardware barrier parameter.

31. The system as claimed in claim 21 wherein:
the integration server receives data in a plurality of locations, from at least one of an enterprise resource report, plant data source, maintenance log, emergency shutdown bypass system, and manual report;
the integration server links received data from the plurality of data sources using source identifiers for the data sources;
each safety critical element data record identifies data sources for integrity performance standards;
the analysis server updates integrity performance standards for each safety critical element associated with received data;
the integrity performance standards include at least one verification task defined for each safety critical element;
the analysis server uses data determined by the integration server to determine task completion and status level; and
the analysis server outputs determinations for the second status and the third status with identification of incomplete tasks of integrity performance standards.

32. The system as claimed in claim 21 wherein:
the warehouse server stores a data record for each safety critical element;
each safety critical element data record includes a plurality of organizational parameters for the organizational structure, a hardware barrier parameter to classify safety critical elements, and an integrity performance standard for the data record based on safety critical element type;
the report server outputs a compliance value of safety critical elements for the organization, a compliance value of safety critical elements for the first status, a compliance value of safety critical elements for the second status, and a compliance value of safety critical elements for the third status;
the report server outputs at least one compliance value for a selected organizational parameter, wherein the at least one compliance value for a selected organizational parameter is presented using data records for safety critical elements;
the report server outputs at least one compliance value for hardware barrier parameters;
the at least one compliance value for hardware barrier parameters includes graphical display elements indicating status for each hardware barrier;
the web server is configured to output the report as an interactive display; and
display elements of the interactive display are presented based on compliance values of the organization, an organizational parameter, and a hardware barrier parameter.

33. An organizational structure comprising a plurality of safety critical elements and the asset integrity management system as claimed in claim 21.

34. An organizational structure as claimed in claim 33, wherein the safety critical elements comprise pumps, pressure vessels, storage tanks, piping systems, relief vents, shutdown systems, control systems, or combinations thereof.

35. A method for monitoring safety critical elements of an organizational structure in an asset integrity management system including an integration server, an analysis server, a warehouse server, a report server, and a web server, the method comprising:
receiving, by the integration server, data from a plurality of data sources for a plurality of safety critical elements of the organizational structure;
linking, by the integration server, received data to safety critical elements of the organizational structure,
outputting, by the integration server, the data to the analysis server and the warehouse server;
storing, by the warehouse server, data received from the integration server into data records for safety critical elements, wherein each safety critical element data record includes at least one organizational parameter, a hardware barrier parameter and integrity performance standard;
updating, by the analysis server, an integrity performance standard for each safety critical element associated with the data, wherein updating the integrity performance standard includes determining a status level for each safety critical element associated with the data records using a first status indicating completion of an inspection plan, a second status indicating completion of an inspection plan with at least one finding to be corrected, and a third status to indicate an incomplete safety plan;
outputting, by the analysis server, each performance standard determination for safety critical elements with at least one of a second status and third status to the warehouse server;
storing, by the warehouse server, performance standard determinations of the analysis server into data records of safety critical elements with at least one of a second status and third status;
generating, by the report server, a report for the organizational structure using the performance standard determinations for safety critical elements determined by the analysis server, data stored by the warehouse server, and safety critical element data records for the organization, the report identifying safety critical elements with the first status, the second status, and the third status;
outputting, by the web server, the report to at least one device as a graphical visualization of operational status of safety critical elements across the organizational structure, the graphical visualization configured to present safety critical elements using at least one of an organizational parameter, and a hardware barrier parameter.
